(19) United States
(12) Patent Application Publication
(10) Pub. No.: US 2010/0081118 A1
(43) Pub. Date: Apr. 1, 2010

(54) System and Method for Prescribing Patient Education

(75) Inventor: Shailja Dixit, Waukesha, WI (US)

Correspondence Address: Andrus, Sceales, Starke & Sawall, LLP, 100 East Wisconsin Avenue, Suite 1100, Milwaukee, WI, 53202-4178, US

(73) Assignee: The General Electric Company, Schenectady, NY (US)

(21) Appl. No.: 12/241,978

(22) Filed: Sep. 30, 2008

(51) Int. Cl. G09B 23/28

(52) U.S. Cl. 434/262

(57) ABSTRACT

A system and method for prescribing education is disclosed herein. The system includes an electronic medical record database, a user input device, a content source, and an education engine. The education engine receives a patient physiological condition from the electronic medical records database, patient information from the user input device, and selects medical education content from the content source in order to create a prescribed education plan. A method of treating a patient with prescribed education is also disclosed herein. The method includes the steps of obtaining a patient understanding level, obtaining a patient literacy level, and obtaining a patient physiological condition. The patient physiological condition and understanding level are used select medical education content for the patient education. The patient literacy level is used to select a media for the patient education. A prescribed education plan is created that comprises the selected medical education content and the selected media.

### BACKGROUND

The present disclosure relates to the field of automated diagnosis and prescription of recommended care. More specifically, the present disclosure relates to a system and method of prescribing an education regimen for treatment of a patient.

Patient medical education has been correlated with improved clinical outcomes. A patient who better understands their physiological condition is often more willing to participate in their care and exhibits increased compliance and/or adherence with a prescribed care plan. A prescribed care plan may include not only prescribed medication, but also lifestyle modifications and/or self management skills.

Unfortunately, the current healthcare reimbursement system does not adequately allow for physicians to determine a patient's medical educational needs and spend time with the patient to meet these needs. Furthermore, there is currently no efficient way of delivering the required medical education content to the patient. Current methods of delivery for medical education content are either cumbersome to assemble, inappropriate for delivery at the healthcare facility, or unlikely to be accessed by the patient outside of the medical care facility.

Current resources of medical education content may include physical pamphlets or information packets; however, these physical materials are difficult to store at a location easily accessed by a clinician, and in the variety required to provide meaningful education regarding the vast number of physiological conditions that may afflict the patient. Another form of medical education content may be a class or group discussion meeting; however, an educational event would take place at another time different from the current meeting between the patient and the clinician. Alternatively, a clinician may direct a patient to online resources, such as one or more websites of a medical society or organization in order to access disease specific medical education content; however, the mere provision of a website address to the patient by the clinician is unlikely to result in the patient accessing the desired medical education content outside of the medical care facility.

### BRIEF DISCLOSURE

A system for prescribing educational treatment for a patient is described in further detail herein. The system includes an electronic medical record database that includes an electronic medical record of the patient and identifies a physiological condition of the patient. The system further includes a content source that includes medical education content of a plurality of media. The system further includes a user input device that accepts the entry of patient information. An education engine is connected to the electronic medical record database, the content source, and the user input device and selects medical education content from the content source based upon the physiological condition from the electronic medical record database and the patient information from the user input device and creates a prescribed education plan that includes the selected medical education content. An output device connected to the education plan engine receives the prescribed education plan and presents the prescribed education plan.

In an alternative embodiment of the system for prescribing education treatment for a patient, the system includes an education engine that is connected to an electronic medical record database that includes an electronic medical record that identifies a physiological condition of the patient. A content source including medical education content is connected to the education engine. The education engine is further connected to an understanding level determination device, a literacy level determination device, and an activation level determination device. The education engine receives inputs indicative of the level of understanding, literacy level, and activation level of the patient. The education engine uses these inputs to select medical education content from the content source and create a prescribed education plan that includes the selected medical education content. An output device connected to the education plan engine receives the prescribed education plan and presents the prescribed education plan to the patient.

A method of treating a patient with prescribed education includes the steps of obtaining a patient understanding level, obtaining a patient literacy level, and obtaining a patient physiological condition. Next, based upon the obtained patient physiological condition and the understanding level, selecting medical education content for the prescribed patient education. Next, based on the patient literacy level, selecting a media for the patient education. Then, creating a prescribed education plan comprising the selected medical education content in the selected media. Finally, the prescribed education plan is presented.

### BRIEF DESCRIPTION OF THE DRAWINGS

FIG. 1 is a system diagram of an embodiment of a system for prescribing educational treatment for a patient;

FIG. 2 is a system diagram of an alternative embodiment of a system for prescribing educational treatment for a patient and a system for delivery thereof; and

FIG. 3 is a flow chart depicting an embodiment of a method of treating a patient with prescribed education.

### DETAILED DISCLOSURE

Patient education plays an important role in improving clinical outcome. A patient who understands his or her physiological condition will be more willing to participate in his or her own care and as a result will better comply with and/or adhere to a prescribed care plan. A care plan may be prescribed to a patient in response to a diagnosis of a physiological condition of the patient. The care plan prescribed to the patient may include a medication and/or other therapy regimen, but may also include lifestyle modifications and/or self-management skills. Lifestyle modifications and self-management skills may include changes to patient nutrition, exercise, use of relaxation techniques, changes to a sleeping schedule, or stress reduction techniques; however, the prescribed care plan is not herein limited to these examples.

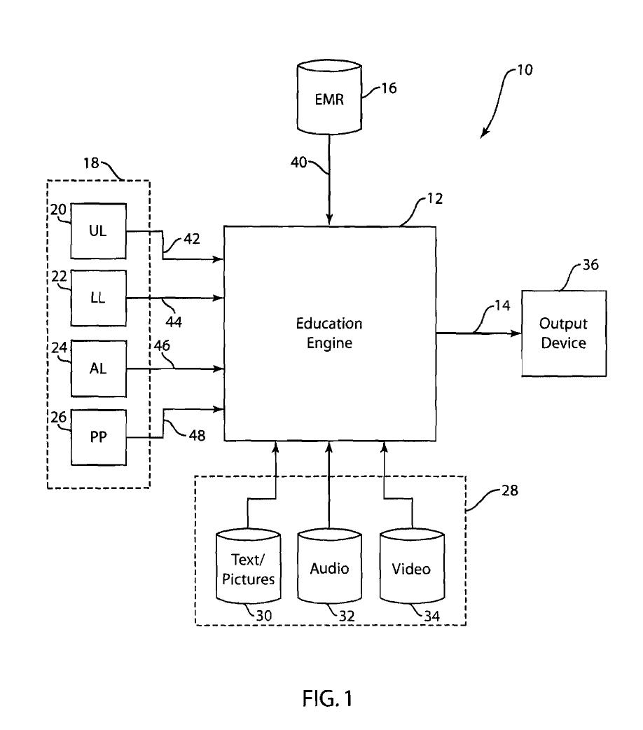

FIG. 1 depicts an embodiment of a system 10 for prescribing educational treatment for a patient. The system 10 includes an education engine 12. The education engine 12 receives a variety of inputs as will be described in further detail herein and produces an output of a prescribed education plan 14. The education engine 12 may be implemented using a specific or general purpose processor performing operations defined by computer code to process the inputs as described herein under any one of a number of data processing techniques, such as, but not herein limited to Boolean logic, fuzzy logic, neural networks, decision trees, and/or other algorithm based systems to create the prescribed education plan 14.

The education engine 12 is connected to an electronic medical record (EMR) database 16. The EMR database 16 is populated with the patient's electronic medical record. Preferably, the EMR database 16 is populated with a plurality of patient electronic medical records, such that the EMR database 16 may provide access to the electronic medical record of a large number of the patients served by a healthcare provider. The electronic medical records stored in the EMR database 16 may include patient identification information, including patient demographics such as age, sex, weight, gender, race, and primary language, but also includes patient diagnostic information including a current diagnosis of an identified physiological condition of the patient. The patient information residing in the electronic medical record should not herein be limited to that already described, but may also include patient medication information, physiological test results, or any other patient information was would be recognized by one skilled in the art.

The EMR database 16 provides an indication of the physiological condition 40 of the patient to the education engine 12.

The education engine 12 is further connected to a user input device 18. The user input device 18 may actually include one or more user input devices as one skilled in the art would deem suitable for implementation of the system 10 and the entry of information into the system 10 through the user input device 18. The user input device 18 may include a keyboard, mouse, or touch screen. The patient and/or a clinician may enter the patient information into the user input device 18. In some embodiments, the user input device 18 may include a machine for reading and recording clinician or patient input on machine-readable papers, such as those available from ScanTron® of Irvine, Calif.

The user input device 18 may further include (or in alternate embodiments be associated with) a variety of units or devices for obtaining specific patient information. An understanding level determination device 20 receives patient information from the patient or a clinician that is indicative of the patient's level of understanding of the patient physiological condition. The understanding level determination device may include a test that is given to the patient with basic questions regarding the diagnosed physiological condition. This test may be taken by the patient using either a computer terminal and a user input device such as a mouse, keyboard, or touch screen, or the test may be administered to the patient on paper and scored using an automated test scoring machine. Alternatively, the clinician may enter observations and/or an assessment of the patient's understanding of the diagnosed physiological condition as determined after the clinician has asked the patient to respond to a variety of questions covering aspects of the diagnosed physiological condition.

A literacy level determination device 22 may be a part of, associated with, or incorporate the user input device 18 to obtain patient information relating to the patient's literacy level. Similar to the understanding level determination device 20, the literacy level determination device 22 may include a variety of techniques and/or methods for eliciting responses from the patient by which the patient's literacy level may be determined. These responses may be elicited through the implementation of a test whereby the patient provides patient information in the form of answers to the test, which may include a reading sample and reading comprehension questions. Alternatively, the clinician may enter observations and/or assessments of the patient's literacy level into the literacy level determination device 22 in order to provide patient information indicative of the patient literacy level based upon the administration of a literacy test to the patient by the clinician, a discussion with the patient regarding the patient's literacy level, or questions that the clinician may ask of the patient regarding the patient's literacy level.

An activation level determination device 24 may further be included in, associated with, or comprise the user input device 18. The activation level determination device 24 operates to obtain patient information from the patient or a clinician, the patient information being indicative of the patient activation level. The patient's activation level is representative of the patient's compliance, lack of compliance, or effort to comply with a prescribed care plan. A patient with a low activation level exhibits limited compliance with a prescribed care plan, and may exhibit no compliance without supervision or even resistance to compliance. Patients with a high level of activation adhere or attempt to adhere to the prescribed care plan, including medications, lifestyle modification, and self-management skill elements of the care plan. A highly activated patient may seek to establish and achieve broader health and/or fitness goals than the minimum that may be prescribed by a care plan.

The activation level determination device 24 may use a survey or other questionnaire implementation with the user input device 18 in order to obtain this patient information directly from the patient. Alternatively, a clinician may conduct an interview with the patient and enter the clinician's own observations and assessments regarding the patient's activation level based upon this interview with the patient into the activation level determination device 24. In a still further embodiment, the activation level determination device 24 is further connected to an alternative source of patient information such as the EMR database 16 or another source of stored patient information (not depicted). This alternative source of patient information may include medical history information regarding the patient that is indicative of the patient's activation level in response to other diagnosed physiological conditions, or the patient's ongoing activation level with respect to physiological conditions that are currently being treated. This patient activation information may be received from automated patient care systems that include tracking of medication regimen compliance, weight and/or fitness improvements over time, or changes to the patient self-management skills.

Some embodiments of the system 10 may further include a patient preference determination device 26 that is included in, associated with, or comprises the user input device 18. The patient preference determination device 26 obtains patient information from the patient and/or a clinician that is indicative of the patient's preference in medical education content, delivery, or schedule, as will be disclosed in further detail herein.

A content source 28 is connected to the education engine 12. The content source 28 may be any suitable source such as a database or other form of content data organization. The content source 28 may be implemented using a computer memory device or server connected to a processor and operating one or more computer programs to store and organize a variety of content data as will be disclosed in further detail herein.

The content data stored in the content source 28 is the medical education content that comprises a plurality of media through which the content may be presented. The medical education content is directed to a variety of specific physiological conditions and includes information about those conditions, the treatment options and procedures commonly used for the physiological condition, and other additional information that may be pertinent to a patient having been diagnosed with the particular physiological condition. The medical education content may also have different content within the same media or have content in multiple different medias that present similar medical education information, but directed towards patients of different levels of understating, literacy, or activation.

Additionally, the medical education content comprises a variety of different media for presentation of the medical education content. The media comprised by the medical education content may include media such as textual or pictorial resources, audio resources, or video resources. As an exemplary embodiment, the content source 28 has been depicted in FIG. 1 as comprising the medical education content sorted by media with a textual content database 30, an audio content database 32, and a video content database 34. It should be understood that the content source 28 may be organized in other ways such as would be recognized by one skilled in the art. Some examples of such alternatives embodiments of the organization for the content source 28 would be organization of the medical education content by level of literacy, understanding, or activation to which the medical education content is directed, or organization of the medical education content by the specific physiological condition to which the medical education content is directed.

In a still further embodiment, the medical education content may be delivered to the patient in a variety of ways. The content source 28 may be organized by a delivery method for the medical education content. The delivery method of the medical education content may include a wide variety of common telecommunications delivery methods as are commonly used for particular types of media. Textual media may be delivered by email, web pages, text messages or other short message service (SMS), or may be delivered to the patient by postal mail if the medical education content is a physical brochure, article, or the like. If the medical education content media is audio media then the delivery methods may be in the form of streaming audio broadcast via the internet, or downloadable audio files such as MP3 or other similarly formatted audio files. Alternatively, audio-based medical education content may be transmitted to the patient via live or recorded phone calls that are scheduled to be placed to the patient at a particular time. Finally, if the medical education content comprises video media, then the medical education content may be delivered by streaming video and/or downloadable video files via the internet, or a physical VCR or DVD may be delivered to the patient via the postal mail or delivered in person before the patient leaves the medical care facility. Therefore, the content source 28 may be arranged in any of the aforementioned ways or any others that would be recognized by one skilled in the art.

The education engine 12 is connected to the EMR database 16, the user input device 18, and the content source 28. In operation, the education engine 12 is able to access the electronic medical record of a patient from the EMR database 16 in order to receive the identification of a physiological condition of the patient 40. The education engine 12 receives patient information from the user input device 18. As stated above, the patient information may be either entered by the patient into the user input device 18, or may be entered by a clinician who is reporting either the clinician's observation and assessment of the patient or is reporting patient information obtained from the patient. The patient information received from the user input device 18 includes one or more of understanding level patient information 42; literacy level patient information 44; activation level patient information 46; and patient preference patient information 48.

The education engine 12 uses a microcontroller to operate a computer program or a computer program module that uses algorithms and/or other types of rules or logic to identify one or more of an understanding level of the patient, literacy level of the patient, activation level of the patient, or preferences of the patient from the received patient information (42, 44, 46, 48). The education engine 12 further uses a microcontroller operating a computer program or program module to match the determined understanding level, literacy level, activation level or patient preferences with the received physiological condition indication 40 in order to determine what medical education content should be included from the content source 28 in a prescribed education plan 14. Once the medical education content has been determined and selected from the content source 28, the education engine 12 creates a prescribed education plan 14. The prescribed education plan 14 is sent to an output device 36 that facilitates the presentation of the medical education content to the patient.

The output device 36 may be a computer workstation that is associated with the clinician designated to provide care to the patient such that the clinician is notified of the prescribed education plan. The clinician then relays the prescribed education plan to the patient. The output device 36 may further be a graphical display upon which the prescribed education plan is presented. The output device 36 may further present indications of physical medical education content such as books, magazines or pamphlets that the clinician must acquire in order to provide this medical education content to the patient. This physical medical education content may further include a brochure, a paper article, an audio CD or a video DVD. In other instances, the output device 36 may be a computer workstation, portable computer, or handheld computing device, and the output device 36 is used to present the medical education content to the patient directly.

The education engine 12 may further determine a schedule for delivery of the medical education content to the patient as part of the prescribed education plan 14. The schedule of the delivery of the medical education content to the patient may be a very important aspect in raising the patient's activation level or participation in the patient's prescribed education plan or prescribed care plan. The schedule created by the education engine 12 may take into account patient preference patient information 48 received through the user input device 18 to indicate the best times for delivery of particular medical education content media to the patient. Such scheduling may include the email or other electronic transfer of medical education content to a patient in the morning or in the evening such that the medical education content may be available on an output device 36 that is a mobile personal computing device. In these instances, the patient may be able to access textual, audio, or video files while the patient commutes to or from work or the patient may have the medical education content available to the patient for review over lunch, in the evening, or during other free time. The schedule of the delivery of the medical education content to the patient as part of the prescribed education plan 14 may further include the scheduling of group classes or group discussions for the patient to attend wherein the patient may receive additional medical education content presented by a trained clinician or a medical educator.

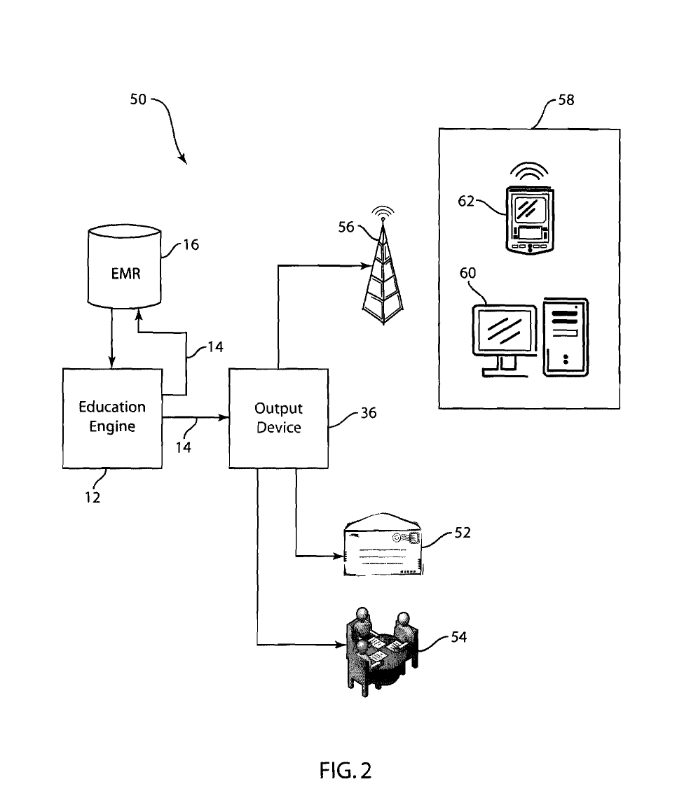

FIG. 2 depicts a medical education content delivery system 50. It should be noted that like reference numerals in FIGS. 1 and 2 refer to embodiments of the same general system elements. In one embodiment, the elements of FIGS. 1 and 2 may be implemented simultaneously in the form of a single integrated medical education system. In FIG. 2, the education engine 12 produces a prescribed education plan 14 as is described above. The prescribed education plan may be transmitted to an output device 36 as described above and will be described in further detail herein. The prescribed education plan 14 may also be transmitted from the education engine 12 to the EMR database 16 wherein the prescribed education plan 14 may be stored in conjunction with the electronic medical record of the patient such that the prescription and progress of the patient's treatment in conjunction with the prescribed education plan may be referenced, tracked, and evaluated.

The output device 36, in one embodiment, may be an automated data processing system as part of a hospital IT infrastructure and located on a server wherein the output device 36 includes computer programs or program modules that operate on a general purpose computer or processor and are designed to maintain or track the patient's prescribed education plan 14 and deliver the medical education content according to a schedule defined in the prescribed education plan 14.

The output device 36 of this embodiment may coordinate the mailing of physical brochures, literature, or disks of digital medical education content through the postal mail 52. The output device 36 may achieve these functions by sending a textual or other notification to a clinician or an administrative worker that indicates the medical education content to be mailed and the address to which it should be mailed. The output device 36 may further coordinate group classes, discussion groups, or individual patient/clinician meetings 54 in order for the patient to receive verbal medical education content. The meetings 54 may be scheduled by the output device 36 according to the patient's prescribed education plan 14. The output device 36 may achieve such meetings 54 by sending notifications to the participants of the meeting at a predetermined schedule. The notification sent out by the output device 36 can be textual or otherwise and may be as determined by the patient and/or clinician to be the best format for him or her to receive such notices.

The output device 36 is further connected to a data transmission system 56 such as a wired or wireless connection to the Internet. The data transmission system 56, besides including a wired or wireless connection to the Internet may also include other forms of telecommunications such as WiFi, Bluetooth, or cellular communication. The medical education content delivery system 50 uses the data transmission system 56 to deliver the medical education content to the patient with an associated electronic device 58. This electronic device 58 may be a computer workstation 60 or a handheld personal digital assistant or other smart device 62. The computer workstation 60 may be connected to the data transmission system 56 via a wired or wireless connection; however, the handheld device 62 is likely to be connected to the data transmission system 56 using a wireless communications platform such as cellular, WiFi, or Bluetooth communications. Thus, the output device 36 may control the transmission of medical education content to a remotely located patient via the electronic device 58. Thus, the patient may remotely receive medical education content in a variety of different digital media. This may include SMS messages, cellular or VIOP calls, email, podcasts, streaming video, or downloadable audio and/or video files. The patient may also be directed via an email or SMS message to access a particular webpage with the prescribed medical education content. The medical education content may be delivered to the patient on the electronic device 58 according to the schedule as defined in the prescribed education plan 14.

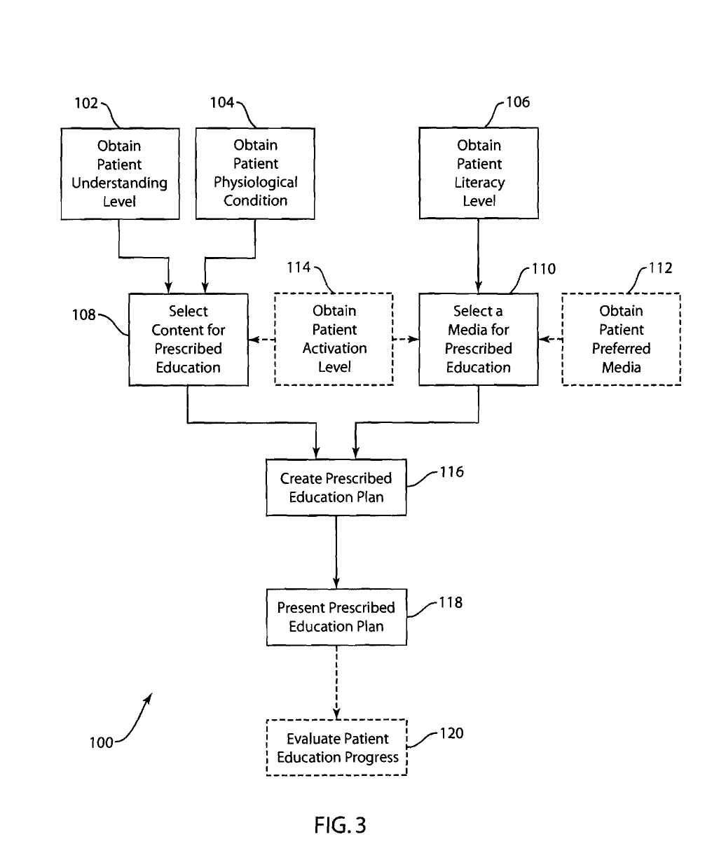

FIG. 3 is a flow chart depicting an embodiment of a method 100 of treating a patient with prescribed education. In the method 100, patient information must first be obtained. This includes obtaining a patient understanding level 102; obtaining a patient physiological condition 104; and obtaining a patient literacy level 106. As has been described previously, the patient physiological condition may be obtained at 104 from an electronic medical record or other healthcare information storage system. The patient understanding level may be obtained in step 102 and the patient literacy level obtained in step 106 by the clinician administering various types of understanding and/or literacy level tests to the patient. The patient may then provide answers or responses to these questions back to the clinician. The clinician can use these answers to obtain the patient's understanding level for step 102 and obtain the patient's literacy level for step 106. In an alternative embodiment, the patient may use a user input device to provide answers to an automated test for determining understanding and/or literacy level. The patient's understanding and literacy levels may be obtained from the analysis of these answers.

Next, at step 108 the content for the prescribed education is selected. The medical education content is selected based upon the patient's understanding level obtained in step 102 and the patient's physiological condition obtained in step 104. The medical education content is directed to the specific physiological condition from which the patient suffers and is also directed to the proper understanding level of that particular patient. If the medical education content does not match the patient's understanding level, the medical education content may not provide the patient with the necessary information in order to increase the patient understanding to a desired understanding level in order to result in improved patient activation. If the patient is presented with too difficult of medical education content for the patient's understanding level, then the patient may not have the understanding to interpret the content or may not be able to identify the reasons for which the content was provided. Similarly, the medical education content is directed to a level of understanding for the patient that is too low, the patient may be forced to review medical information that the patient already knows and the patient's understanding will not be improved as no new material has been presented to the patient.

At step 110, a media for the prescribed education is selected. The media for the medical education content may be based on the patient literacy level obtained in step 106. If the patient has a limited literacy level, then the media through which the medical education content may be presented to the patient will be limited. If medical education content that is too hard for the patient literacy level is presented to the patient, the patient may not be able to fully understand the medical education content and the patient's level of understanding will not be improved by the patient's review of the medical education content.

If the patient has a low literacy level, then medical education content media may be selected such as group classes, group discussions, meetings with clinicians, and audio or video presentations. If the patient has a higher level of literacy, then media such as internet webpages, email, journal articles, or SMS messages may be incorporated.

Optionally, the additional step of obtaining patient preferred media at step 112 may be performed. The patient preferred media obtained in step 112 may be used to help select the media for the prescribed education in step 110. The patient may have a media preference that best fits the patient's schedule, preferred media delivery format, or learning style. The patient may know that he or she learns best when the medical education content is presented aurally, while other patients may learn better when the medical education content is presented visually. Thus, the patient may have input into selecting the media of the medical education content which may further promote improvement in the patient's activation level.

In another optional step, that of step 114, the patient's activation level is obtained. If the patient's activation level has been determined either through surveys, tests, a patient interview with a clinician, or an analysis of previous patient medical records, this can be used in one or both of selecting the content for the prescribed education in step 108 and in selecting a media for the prescribed education in step 110. If the patient has a low activation level, often the patient typically also has a low understanding level and must be prescribed with medical education content directed to increasing the patient's understanding level. However, in some cases, as will be detailed in further detail below, the patient's low activation level may have another root cause and the patient's prescribed education plan may be modified to reflect this. Additionally, if the obtained patient activation level in step 114 is high, then the patient is likely to be more active in gathering and reviewing information about the patient's physiological condition. In this instance additional medical education content may be selected in step 108 and multiple forms of media may be selected for the patient in step 110.

Once the medical education content for the prescribed education has been selected in step 108 and the media for the prescribed education has been selected in step 110, a prescribed education plan is created in step 116. The prescribed education plan created in step 116 identifies both the selected medical education content from step 108 and the selected media from step 110. The prescribed education plan created in step 116 is then presented in step 118. The prescribed education plan is presented in step 118 to one or both of the clinician and the patient. The prescribed education plan may notify the patient of the selected medical education content and the selected media. Furthermore, the prescribed education plan presented in step 118 further includes the presentation of the medical education content to the patient in the selected media. This presentation may occur over the course of the prescribed education plan which may be scheduled over a time period of a day, a week, a month, or longer.

Finally, in an optional step, the patient's education progress may be evaluated in step 120. At a predetermined time or date in accordance with the prescribed education plan, one or more of the patient's understanding level, literacy level, or activation level may be obtained and re-evaluated to determine whether there has been a shift in any of these pieces of patient information. At that time, the method may be repeated in order to update the patient's prescribed education plan in order to include updated medical education content and updated media in order to further the patient's education about the patient's physiological condition.

The step of evaluating patient education progress in step 120 may be performed by the periodic testing or evaluation of the patient to identify any improvements of patient understanding, activation level, or literacy level. The evaluation of the patient's progress may also include monitoring the patient's improvement or management of the physiological condition or the patient's adherence to other prescribed elements of a patient care plan. This additional feedback gives the clinician an additional tool in evaluating the patient's progress and whether any modifications need to be made to the patient's prescribed care plan or prescribed education plan.

In an alternative embodiment, patient demographic information may be obtained. The patient demographic information may be obtained from a patient's electronic medical record as may be found on an EMR database. The patient demographic information may include, but is not limited to, race, ethnicity, age, sex, weight, and natural or preferred language. These additional demographic considerations may be used in the steps of selecting content, selecting media, and creating a prescribed education, which may be performed by an education engine in order to further tailor the prescribed education plan to the individual patient. In such embodiments, the content may be selected to be in a native or preferred language in order to facilitate improving the patient's understanding level through medical education.

Alternatively, it may be determined that particular demographic groups (i.e. based on age, sex, or ethnicity) may prefer some types of media or content over other forms of medical education. Younger patients may be more accepting to newer communication technologies such as downloadable audio files or streaming video in order to receive their medical education content whereas older patients may prefer a more physical, text-based media such as pamphlets or magazines. Additionally, based upon demographic consideration, it may be determined that patients of particular demographics may require additional medical education content in order to improve their activation level. It may be determined that patients of particular demographics may be resistant or unmotivated to adhere to a prescribed care plan or particular elements thereof. One example of this may be patients from Asian cultures that may be used to medical techniques that are much different than those found in Western practice. These patients may suffer from a low activation level due to the unfamiliarity with these medical practices. Therefore these patients may need additional medical education content directed to explaining these practices in order to introduce them to these unfamiliar techniques. Once these patients understand the techniques better, their adherence to the prescribed care plan and their activation level in their treatment will hopefully improve.

A few examples of different hypothetical patients will be presented in order to further point out the operation and benefits of embodiments of the disclosed system and method.

A patient with a low understanding level and a low literacy level may require content that is selected to provide a basic understanding of the patient's physiological condition. However, due to the patient's low literacy level, media such as group classes, clinician interviews, or audio and/or video files may be selected in order to present the medical education content to the patient in a way that would offer the best chance at the patient understanding and retaining the medical education content. Alternatively, text based medical education content may be provided that is written to be presented at a lower literacy level. The basic information regarding the physiological condition may include identifying the symptoms and limitations that the patient may experience with the diagnosed physiological condition, as well as the potential risks associated with the physiological condition if the patient does not adhere to the prescribed care plan.

Next, if a patient is determined to have a low understanding level but a high literacy level, the media for the prescribed education plan may be selected to be web pages or other textual based resources written at a literacy level commensurate with the patient's literacy level. Additionally, the complexity of the medical education content may be higher to match the patient's literacy level and more in depth information regarding the patient's physiological condition and the risks associated with it may be provided to the patient.

Alternatively, it may be determined that the patient has a low understanding level and a low activation level due to the patient's inability to review the prescribed education content because of scheduling concerns. The patient may be very busy and unable to find time to devote to the prescribed medical education plan. In these instances, the media and the schedule in the prescribed education plan may be selected in order to match the patient's schedule. This may include the delivery of the medical education content to the patient's email, or the use of downloadable audio files or podcasts such that the patient may listen to or review the medical education content in a media or at a time that is convenient for the patient such as during a commute to or from work, over a lunch break, or while the patient is at the gym.

Finally, in an example wherein it is determined that the patient has a high level of understanding, literacy, and activation, the patient's prescribed education plan may direct the patient to additional and/or more active medical education resources such as support groups, research articles, or other ways to become actively involved with other patients with the same or similar physiological condition.

Some embodiments of the system and method as disclosed herein may be performed solely through the use of a computer. In these embodiments, one or more microprocessors access and execute the code of one or more computer programs, sub-programs, or program modules in order to achieve the functionality and methods as disclosed herein. In these embodiments, the technical effect of the system and method as disclosed herein is that of improving patient care by automatedly adding an educational component to the patient's prescribed treatment and further monitoring the patient's progression with this education component of the patient's treatment.

This written description uses examples to disclose various embodiments, including the best mode, and also to enable any person skilled in the art to make and use these embodiments. The patentable scope is defined by the claims may extend to include other examples not explicitly listed that occur to those skilled in the art. Such other examples are intended to be within the scope of the claims if they have structural elements that do not differ from the literal language of the claims, or if they include equivalent elements with insubstantial differences from the literal languages of the claims.

Various alternatives and embodiments are contemplated as being with in the scope of the following claims, particularly pointing out and distinctly claiming the subject matter of the present disclosure.

What is claimed is:

1. A system for prescribing educational treatment for a patient, the system comprising:
an electronic medical record database comprising an electronic medical record of the patient, the electronic medical record identifying a physiological condition of the patient;
a content source comprising medical education content, the medical education content comprising a plurality of media;
a user input device arranged to accept the entry of patient information from a user, the user input device receiving the patient information entered by the user;
an education engine that receives the physiological condition of the patient from the electronic medical record database and receives the patient information from the user input device, the education engine selecting medical education content from the content source based upon the received physiological condition and the patient information and creating a prescribed education plan comprising the selected medical education content; and
an output device that receives the prescribed education plan from the education engine and presents the prescribed education plan.

2. The system of claim 1, further comprising an understanding level determination device connected to the user input device that receives patient understanding information from the user input device, wherein the patient understanding information is indicative of an understanding level of the physiological condition.

3. The system of claim 2 further comprising a literacy level determination device connected to the user input device that receives patient literacy level information from the user input device, wherein the patient literacy level information is indicative of the patient's literacy level.

4. The system of claim 3 further comprising an activation level determination device connected to the user input device that receives patient activation information from the user input device, wherein the patient activation information is indicative of a patient's activation level.

5. The system of claim 4 wherein the prescribed education plan further comprises a selected media, schedule, and a delivery method.

6. The system of claim 5 wherein the selected media, schedule, and delivery method are further determined by the education engine based upon the patient understanding information, patient literacy level, and patient activation information.

7. The system of claim 6 further comprising a patient preference determination device connected to the user input device that receives patient preference information from the user input device, wherein the patient preference information is indicative of at least one of the selected media, education schedule, and delivery method and the prescribed education plan is further determined based upon the received patient preference.

8. The system of claim 6 wherein the education engine further comprises a plurality of rules to which the received understanding level, literacy level, and activation level are applied, wherein the application of the understanding level, literacy level, and activation level to the plurality of rules determines the selected media, schedule, and delivery method in the prescribed education plan.

9. The system of claim 5 wherein the content source further comprises textual, audio, and video medical education content.

10. The system of claim 5 wherein the content source further comprises an identification of a hard copy of textual medical education content, the prescribed education plan further comprising the identification of the hard copy of textual medical education content.

11. A system for prescribing education treatment for a patient, the system comprising:
an electronic medical record database comprising an electronic medical record of the patient, the electronic medical record identifying a physiological condition of the patient;
a content source comprising medical education content, the medical education content comprising a plurality of media;
an understanding level determination device that receives a first user input indicative of the patient's understanding level of the physiological condition;
a literacy level determination device that receives a second user input indicative of the patient's literacy level;
an activation level determination device that receives a third user input indicative of the patient's activation level;
an education engine that receives the physiological condition from the electronic medical record database and receives the understanding level, literacy level, and activation level, the education engine selecting medical education content from the content source based upon the received physiological condition, understanding level, literacy level, and activation level and creating a prescribed education plan comprising the selected medical education content;
an output device that receives the prescribed education plan from the education engine and presents the prescribed education plan.

12. The system of claim 11 wherein the content source further comprises textual, audio, and video medical education content.

13. The system of claim 12 wherein the prescribed education plan further comprises a schedule and delivery method for the selected medical education content.

14. The system of claim 13 wherein the delivery method is selected from a list comprising: an email, a streaming video, a digital audio file, a telephone call, an in-person meeting, a group class, short message service, and postal mail.

15. A method of treating a patient with prescribed education, the method comprising the steps of:
obtaining a patient understanding level;
obtaining a patient literacy level;
obtaining a patient physiological condition;
based on the patient physiological condition and the patient understanding level, selecting medical education content for the prescribed education;
based upon the patient literacy level, selecting a media for the prescribed education;
creating a prescribed education plan comprising the selected medical education content and the selected media; and
presenting the prescribed education plan.

16. The method of claim 15, wherein the media for the prescribed patient education is selected from a list comprising: one-on-one counseling, group classes, support group attendance, pamphlets, video files, audio files, web pages available on the Internet, email, and short message service.

17. The method of claim 15, further comprising the steps of:
obtaining a patient activation level; and
if the level of patient activation is low, identifying the cause of the low patient activation.

18. The method of claim 17, further comprising modifying the selected media for the prescribed education if the cause of the low patient activation is identified to be that the patient is busy.

19. The method of claim 18, further comprising selecting a schedule for the prescribed education, wherein the prescribed education plan further comprises the selected schedule.

20. The method of claim 17, further comprising:
obtaining the patient's preferred education media; and
modifying the selected media for the prescribed education to match the obtained preferred education media.
